(19) United States
(12) Patent Application Publication
(10) Pub. No.: US 2010/0139715 A1
(43) Pub. Date: Jun. 10, 2010

(54) Cleaning Equipment and Cleaning Method

(76) Inventors: Sang-Jine Park, Yongin-si (KR); Chang-Seon Jeon, Yongin-si (KR); Young-Eun Kim, Ansan-si (KR)

Correspondence Address: F. CHAU & ASSOCIATES, LLC, 130 WOODBURY ROAD, WOODBURY, NY, 11797, US

(21) Appl. No.: 12/619,189

(22) Filed: Nov. 16, 2009

(30) Foreign Application Priority Data
Dec. 10, 2008 (KR) 10-2008-0125014

(51) Int. Cl. B08B 3/00

(52) U.S. Cl. 134/124

(57) ABSTRACT

A cleaning equipment includes a moving module moving a wafer from a first position to a second position, and a cleaning module provided at a third position between the first and second positions and including a plurality of cells, each cell having one or more pairs of outlets and inlets, the outlets for discharging a chemical solution onto the wafer and the inlets for drawings the chemical solution from the wafer, in a movement path of the wafer. The plurality of cells are individually operated.

### CROSS-REFERENCE TO RELATED APPLICATIONS

This U.S. non-provisional patent application claims the benefit of Korean Patent Application 10-2008-0125014, filed on Dec. 10, 2008, in the Korean Intellectual Property Office, the entire contents of which are herein incorporated by reference.

### BACKGROUND

1. Technical Field

The present invention relates to a semiconductor manufacturing equipment and a semiconductor manufacturing method, and more particularly, to scan-type cleaning equipment that cleans wafers while moving the wafers and a wafer cleaning method.

2. Description of Related Art

In general, semiconductor devices can be formed by a plurality of unit processes. A cleaning process is one among the plurality of unit processes. The cleaning process removes contaminants from a wafer. Any contaminants remaining on the wafer directly or indirectly affects subsequent unit processes. Further, the residual contaminants can affect device yield and reliability. Therefore, the cleaning process needs to have reproducibility and accuracy. The cleaning process can be a wet cleaning process or a dry cleaning process. The wet cleaning process is a dip-type cleaning process of putting the wafer into a bath filled with a chemical solution. The dip-type cleaning equipment is not sufficient to adapt to an increase in a diameter of the wafer. In order to solve the above-mentioned problem, a scan-type cleaning equipment has been developed which performs the wet cleaning process on the wafer while moving the wafer. Herein, the term ‘scan-type cleaning equipment’ means a moving and cleaning equipment that cleans the wafer while moving the wafer.

Conventional cleaning equipment discharges and draws a chemical solution in a direction vertical to the direction in which the wafer is moved. However, a large amount of chemical solution is collectively discharged from a plurality of outlets to the wafer and a portion outside the wafer. Therefore, cleaning process costs are increased and productivity is lowered. In addition, since a plurality of inlets collectively draw the chemical solution, a scan tail defect occurs due to a pressure difference caused by a step difference between the wafer and a portion outside the wafer, which results in low manufacturing yield.

### SUMMARY

According to an exemplary embodiment, a cleaning equipment includes an input module for receiving a wafer at a first position, an output module outputting the wafer at a second position, a moving module moving the wafer from the first portion to the second position, and a cleaning module provided at a third position between the first and second positions and including a plurality of cells, each cell having one or more pairs of outlets and inlets, the outlets for discharging a chemical solution onto the wafer and the inlets for drawing the chemical solution from the wafer, in a movement path of the wafer. The plurality of cells are individually operated.

The cleaning module may include an upper cleaning module including the plurality of cells, wherein the outlets of different cells separately discharge the chemical solution onto the wafer and the inlets of different cells separately draw the chemical solution from the wafer at a position above the wafer, and a lower cleaning module including a plurality of collective outlets for collectively discharging the chemical solution and a plurality of collective inlets for collectively drawing the chemical solution at a position opposite to the upper cleaning module with the wafer interposed therebetween.

The upper cleaning module may include an upper chemical cleaning unit that includes the plurality of cells, at least one chemical separation supply unit separately supplying the chemical solution to a first group of the plurality of cells corresponding to the upper chemical cleaning unit, and at least one chemical separation suction unit separately drawing the chemical solution through a first group of the plurality of inlets formed in the plurality of cells.

The lower cleaning module may include a lower chemical cleaning unit including a first group of the plurality of collective outlets that collectively discharge the chemical solution to a lower surface of the wafer and a first group of the plurality of collective inlets that collectively draw the chemical solution from the lower surface.

The lower cleaning module may include at least one chemical collective supply unit collectively supplying the chemical solution to the lower chemical cleaning unit, and a collective suction unit collectively drawing the chemical solution that is collectively discharged from the lower chemical cleaning unit to the lower surface of the wafer.

A cleaning area formed by operating cells has apexes corresponding to the edge of the wafer.

The cleaning equipment may further include a wafer position sensor detecting the position of the wafer.

The wafer position sensor may include a mechanical sensor.

According to another exemplary embodiment, a cleaning method includes operating, selectively, a plurality of cells in a cleaning module to discharge and draw at least one chemical solution to and from a wafer, wherein only cells disposed above the wafer are operated.

According to another exemplary embodiment, the cleaning method may further comprise loading the wafer onto an input module, moving the wafer from the input module to an output module, and detecting the position of the wafer in the cleaning module between the input module and the output module.

According to another exemplary embodiment, the cleaning method may further comprise completing the movement of the wafer from the cleaning module to the output module, and taking out the wafer from the output module.

### BRIEF DESCRIPTION OF THE DRAWINGS

Exemplary embodiments of the present disclosure are described herein with reference to the attached drawings in which:

FIG. 1 is a diagram illustrating cleaning equipment according to an exemplary embodiment of the invention;

FIG. 2 is a perspective view illustrating a cleaning module shown in FIG. 1;

FIG. 3 is a plan view illustrating an upper cleaning module shown in FIG. 2;

FIG. 4 is a plan view illustrating a lower cleaning module shown in FIG. 2;

FIG. 5 is a perspective plan view of FIG. 2;

FIG. 6 is a cross-sectional view taken along the line VI-VI′ of FIG. 5;

FIG. 7 is a diagram illustrating a scan tail defect occurring in a cleaning equipment including inlets for collectively drawing a chemical solution;

FIG. 8 is a graph illustrating the cleaning area of cells disposed above a wafer;

FIGS. 9A and 9B are plan views illustrating a wafer position sensor shown in FIG. 1; and

FIG. 10 is a flowchart illustrating a cleaning method according to another exemplary embodiment of the invention.

### DETAILED DESCRIPTION

Exemplary embodiments of the present disclosure will now be described more fully with reference to the accompanying drawings. In the drawings, the thicknesses of layers and regions may be exaggerated for clarity.

Specific structural and functional details disclosed herein are merely representative for purposes of describing exemplary embodiments. Exemplary embodiments may, however, may be embodied in many alternate forms and should not be construed as limited to only exemplary embodiments set forth herein.

Accordingly, while exemplary embodiments are capable of various modifications and alternative forms, embodiments thereof are shown by way of example in the drawings and will herein be described in detail. It should be understood, however, that there is no intent to limit exemplary embodiments to the particular forms disclosed, but on the contrary, exemplary embodiments are to cover all modifications, equivalents, and alternatives falling within the scope of exemplary embodiments. Like numbers refer to like elements throughout the description of the figures.

It will be understood that, although the terms first, second and third may be used herein to describe various elements, these elements should not be limited by these terms. These terms are only used to distinguish one element from another. For example, a first element could be termed a second element, and, similarly, a second element could be termed a first element, without departing from the scope of exemplary embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular embodiments only and is not intended to be limiting of exemplary embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which exemplary embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

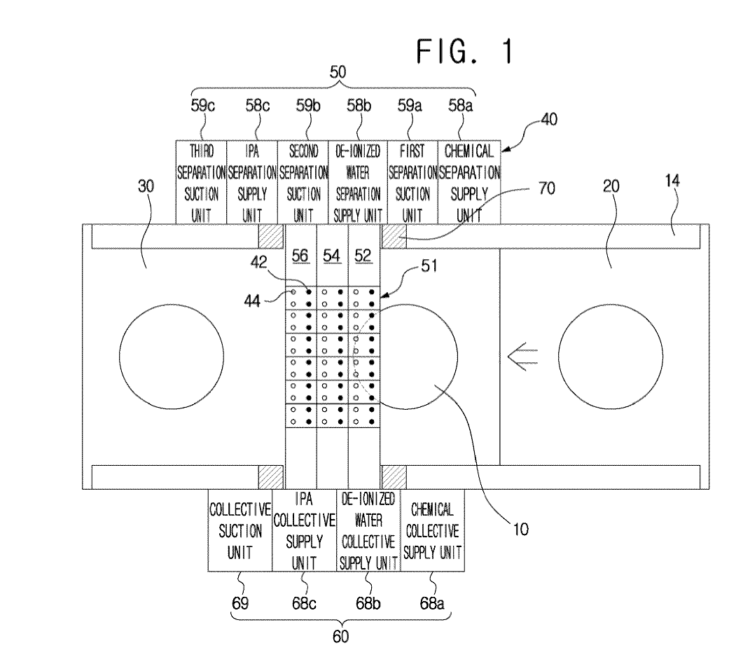

For ease of understanding the function and operation of the following exemplary embodiments of the invention, exemplary embodiments of the invention will be described in detail with reference to FIGS. 1 to 8.

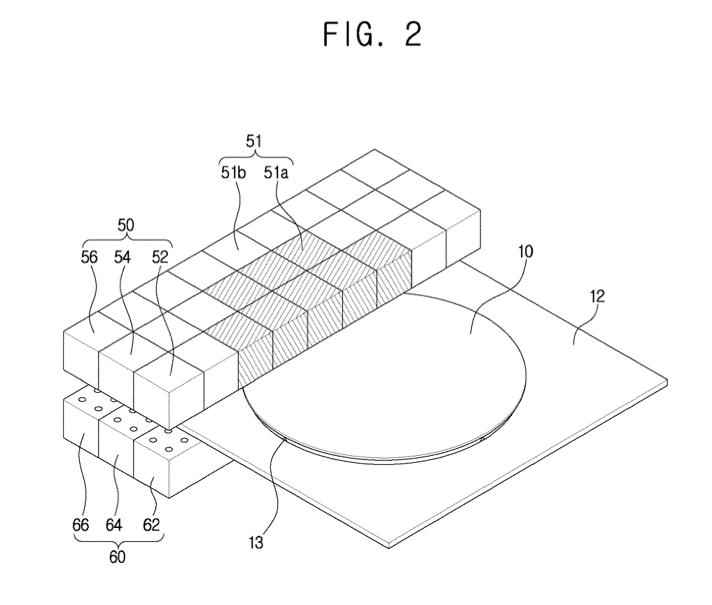

FIG. 1 is a diagram illustrating cleaning equipment according to an exemplary embodiment of the invention. In the cleaning equipment of FIG. 1, a cleaning module 40 between an input module 20 and an output module 30 is divided into a plurality of cells 51 each having one or more pairs of outlets 42 and inlets 44 through which a chemical solution is discharged and drawn. The outlets 42 are individually operated to discharge the chemical solution onto only an upper surface of the wafer 10. The wafer 10 may be loaded on, and unloaded from, the input module 20 and the output module 30 by a wafer transport device, such as an external robot, and the input module 20 and the output module 30 may transport the wafer in the horizontal direction. The wafer 10 may be moved in a horizontal state by a mount plate 12 (see FIG. 2), which is a moving module operated along a linear motion (LM) guide 14.

The cleaning module 40 cleans the wafer 10 moved by the mount plate 12. The cleaning module 40 sequentially exposes the wafer 10 to a chemical solution, de-ionized water, and isopropyl alcohol (hereinafter, referred to as IPA) to clean the wafer 10. The chemical solution, the de-ionized water, and the IPA may be discharged from the outlets 42 and may be drawn through the inlets 44. The chemical solution removes a contaminant on the wafer 10, the de-ionized water cleans the chemical solution, and the isopropyl alcohol dries and removes the de-ionized water remaining on the wafer 10.

Therefore, the cleaning module 40 according to an exemplary embodiment is divided into a chemical cleaning unit, a de-ionized water cleaning unit, and a drying unit according to the kind of liquid being handled.

The cleaning module 40 may clean the lower surface of the wafer 10 in addition to the upper surface of the wafer 10. Semiconductor devices are formed on the upper surface of the wafer 10 by, for example, a dual damascene process. A contaminant, such as a polymer, may be adhered to the lower surface of the wafer 10. The same or different cleaning operations are performed on the upper and lower surfaces of the wafer 10. Therefore, the cleaning module 40 includes an upper cleaning module 50 that cleans the upper surface of the wafer 10 and a lower cleaning module 60 that cleans the lower surface of the wafer 10. The upper cleaning module 50 includes an upper chemical cleaning unit 52, an upper de-ionized water cleaning unit 54, and an upper drying unit 56.

The upper chemical cleaning unit 52, the upper de-ionized water cleaning unit 54, and the upper drying unit 56 each include a plurality of cells 51 each having pairs of adjacent outlets 42 and inlets 44, and are arranged in a line or a predetermined pattern. In an exemplary embodiment of the invention, one cell 51 includes two outlets 42 and two inlets 44 arranged in a line. It is preferable that the upper cleaning module 50 include pairs of separation supply and separation suction units, wherein a separation supply unit separately supplies a liquid to be discharged from the outlets 42 of the cells 51 and a separation suction unit separately draws the liquid.

Therefore, the upper cleaning module 50 includes a chemical separation supply unit 58a that separately supplies a chemical solution to the cells 51 of the upper chemical cleaning unit 52 and a first separation suction unit (chemical separation suction unit) 59a that separately draws the chemical solution from the cells 51. In the disclosure, the term ‘chemical solution’ means all compositions including a chemical solution for cleaning the wafer as a cleaning component, and is not limited to, for example, a liquid or slurry, a suspension, or an emulsion. In the disclosure, the term ‘separation’ means that a plurality of supply units or suction units individually supply or draw a specific material as shown in FIG. 1. The number of supply or suction units is two or more according to a design of an apparatus, but is not limited thereto. The term ‘collectively’ means that only one supply or suction unit supplies or draws a specific material. The cleaning equipment according to an exemplary embodiment of the invention supplies a chemical solution to only the cells 51 disposed above the wafer 10. Therefore, it is possible to minimize the amount of chemical solution supplied from the chemical separation supply unit 58a to the outlets 42, which results in an improvement in productivity. When the chemical cleaning unit 52 is disposed close to the upper de-ionized water cleaning unit 54, the first separation suction unit 59a may draw in a mixture of the chemical solution and the de-ionized water. The first separation suction unit 59a may individually adjust the pressure of air drawn through the plurality of cells 51, wherein the air also includes the chemical solution. According to an exemplary embodiment, the suction pressure of the cell 51 disposed above the center of the wafer 10 may be higher than that of the cell 51 disposed above the edge of the wafer.

The upper cleaning module 50 includes a de-ionized water separation supply unit 58b that separately supplies the de-ionized water to the cells 51 of the upper de-ionized water cleaning unit 54 and a second separation suction unit (de-ionized water separation suction unit) 59b that separately draws the de-ionized water from the cells. Similarly, when the upper de-ionized water cleaning unit 54 and the upper drying unit 56 are disposed close to each other, the second separation suction unit 59b may draw the IPA of adjacent cells 51.

The upper cleaning module 50 further includes an IPA separation supply unit 58c that separately supplies the IPA to the cells 51 of the upper drying unit 56 and a third separation suction unit 59c that separately draws the IPA supplied from the IPA separation supply unit 58c.

The liquid discharged onto the lower surface of the wafer 10 is likely to be easily separated from the wafer 10. According to an exemplary embodiment of the invention, the chemical solution, the de-ionized water, and the IPA are collectively supplied to or drawn from the lower surface of the wafer 10. Therefore, the lower cleaning module 60 may include a chemical collective supply unit 68a, a de-ionized water collective supply unit 68b, an IPA collective supply unit 68c, and a collective suction unit 69.

FIG. 2 is a perspective view illustrating the cleaning module 40 shown in FIG. 1. As shown in FIG. 2, the upper cleaning module 50 disposed above the wafer 10 includes a plurality of cells 51 that separately perform a cleaning operation according to the moved state of the wafer 10, and the lower cleaning module 60 that performs a collective cleaning operation is below the wafer 10. The wafer 10 is supported by a plurality of supporting pins 13 at the center of the mount plate 12 and is moved between the upper cleaning module 50 and the lower cleaning module 60. In the lower cleaning module 60, the lower chemical cleaning unit 62, the lower de-ionized water cleaning unit 64, and the lower drying unit 66 are disposed opposite to the upper cleaning module 50 with the wafer 10 interposed therebetween.

As described above, in the upper cleaning module 50, the upper chemical cleaning unit 52, the upper de-ionized water cleaning unit 54, and the upper drying unit 56 are arranged in a line substantially vertical to the direction in which the wafer 10 is moved. A plurality of operation cells 51 a disposed above the wafer 10 perform a cleaning operation and are shown as hatched cells in FIG. 2 for clarity. A plurality of cells 51 spaced from the wafer 10 are non-operation cells 51b and are shown in FIG. 2 without hatch marks for clarity. Therefore, while the wafer 10 is moved below the upper cleaning module 50, the number of cells 51 that separately perform the cleaning operation may be increased or decreased.

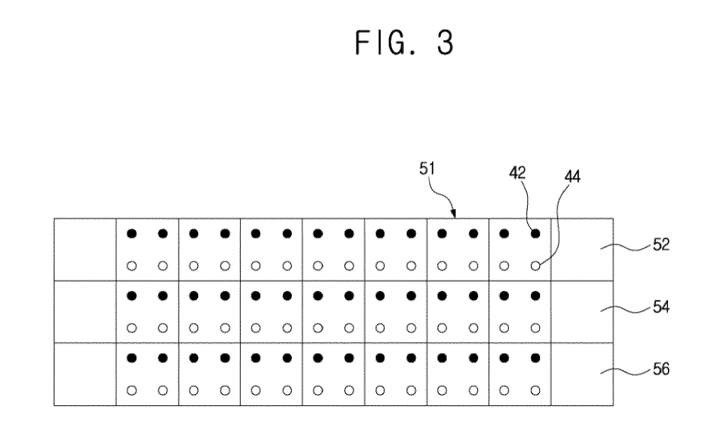

FIG. 3 is a plan view illustrating the upper cleaning module 50 shown in FIG. 2. As shown in FIG. 3, the upper cleaning module 50 includes a plurality of cells 51 each having two pairs of the outlets 42 and the inlets 44. According to an exemplary embodiment of the invention, a plurality of cells 51 may have a square shape. The outlets 42 and the inlets 44 are continuously arranged in the direction in which the plurality of cells 51 are arranged. According to an exemplary embodiment of the invention, each of the outlet 42 and the inlet 44 has a radius of about 0.059±0.001 mm. The outlets 42 and the inlets 44 are arranged at an interval of about 5 mm to about 1 cm.

The distance between the upper chemical cleaning unit 52 and the upper de-ionized water cleaning unit 54 and the distance between the upper de-ionized water cleaning unit 54 and the upper drying unit 56 may be equal or similar to the distance between the plurality of outlets 42 or the distance between the plurality of inlets 44. In this way, the inlets 44 of the upper chemical cleaning unit 52 can draw the de-ionized water discharged from the outlets 42 of the upper de-ionized water cleaning unit 54 from the upper surface of the wafer 10. Therefore, the radius of the inlet 44 of the upper chemical cleaning unit 52 may be greater than that of the outlet 42.

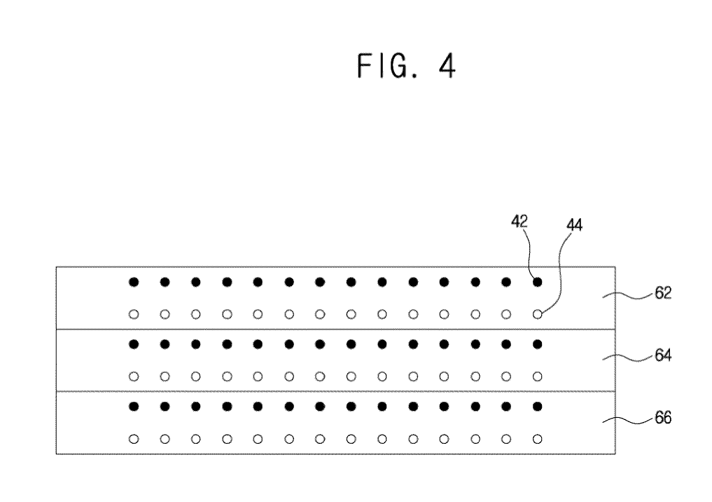

FIG. 4 is a plan view illustrating the lower cleaning module 60 shown in FIG. 2. In the lower cleaning module 60 shown in FIG. 4, a plurality of outlets 42 and a plurality of inlets 44 are arranged substantially parallel to each other. As shown in FIG. 4, the lower chemical cleaning unit 62 of the lower cleaning module 60 collectively discharges a chemical solution onto the lower surface of the wafer 10 through a plurality of outlets 42 (collective outlets) and collectively draws the chemical solution in through a plurality of inlets 44 (collective inlets). The size of the outlets 42 and the inlets 44 of the lower cleaning module 60 may be equal or similar to that in the upper cleaning module 50. Similarly, the plurality of inlets 44 formed in the lower chemical cleaning unit 62 and the lower de-ionized water cleaning unit 64 may have a size greater than that of the outlets 42. Thus, the inlets 44 of the lower chemical cleaning unit 62 may draw in the de-ionized water in addition to the chemical solution. The outlets 42 and the inlets 44 of the lower drying unit 66 may have the same or similar size.

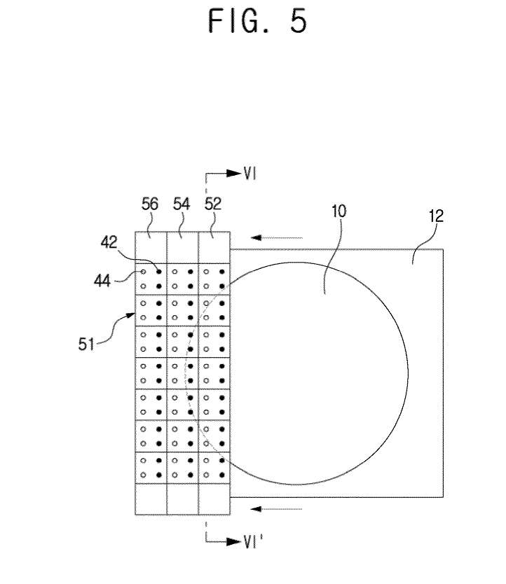

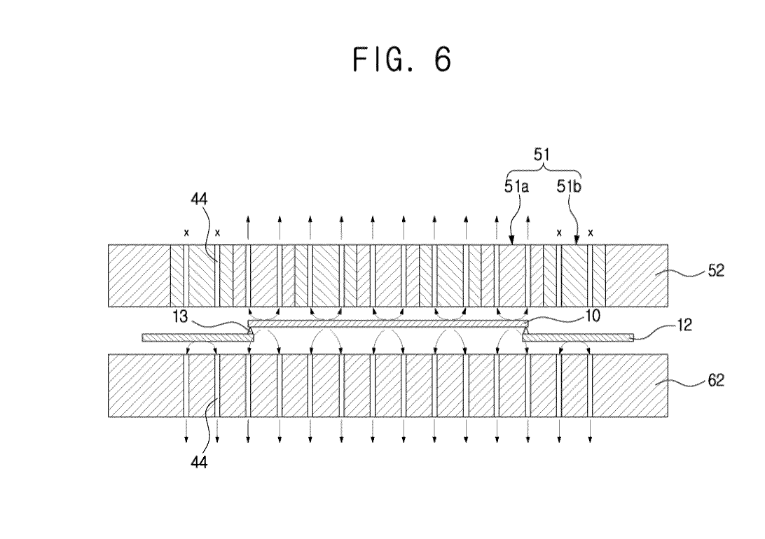

FIG. 5 is a perspective plan view of FIG. 2, and FIG. 6 is a cross-sectional view taken along the line VI-VI′ of FIG. 5.

As shown in FIGS. 5 and 6, the upper chemical cleaning unit 52 draws the chemical solution from the upper surface of the wafer 10 through only the inlets 44 formed in a plurality of cells 51 that are disposed above the wafer 10. The inlets 44 of the other cells 51 disposed outside the wafer 10 do not draw the chemical solution. The lower chemical cleaning unit 62 draws the chemical solution exposed from the entire lower surface of the wafer 10 through the inlets 44. In FIG. 6, arrows indicate the flow direction of the chemical solution.

According to an exemplary embodiment of the invention, there is a predetermined step difference between the mount plate 12 and the wafer 10. Only the cells 51 disposed above the wafer 10 are operated to draw the chemical solution. Therefore, the chemical solution can be drawn from the upper surface of the wafer 10 at a uniform pressure regardless of the step difference in the periphery of the wafer 10. That is, the chemical solution is drawn at a uniform pressure only in a narrow gap between the wafer 10 and the upper chemical cleaning unit 52. Since a plurality of cells 51 draw the chemical solution at the same level, a scan tail defect due to a difference in pressure can be substantially avoided.

The lower chemical cleaning unit 62 includes the inlets 44 for collectively drawing the chemical solution. Therefore, the lower chemical cleaning unit 62 can collectively draw the chemical solution from the wafer 10 that is higher than the mount plate 12. The reason is that, since the gap between the inlets 44 and the wafer 10 is larger than that between the inlets 44 and the mount plate 12, it is possible to draw a large amount of air and chemical solution.

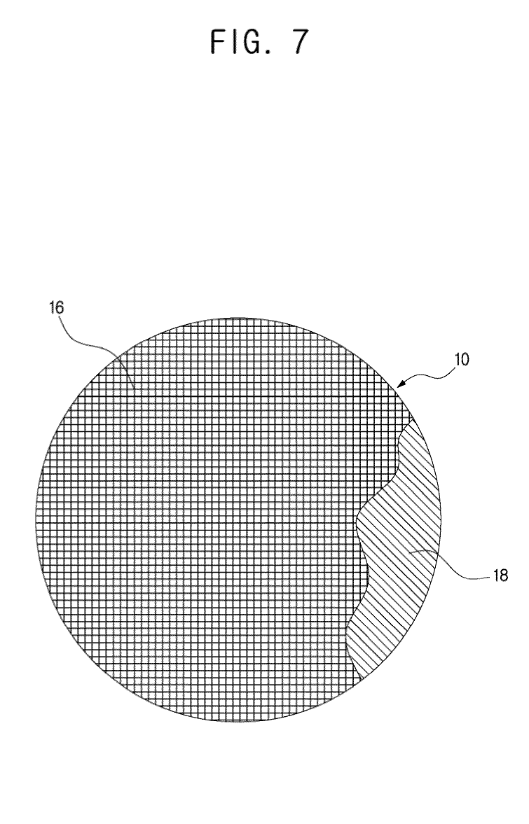

FIG. 7 is a diagram illustrating the scan tail defect occurring in the cleaning equipment that includes collectively-drawing-type inlets. In related art systems, the inlets collectively draw a chemical solution, de-ionized water, and IPA regardless of the movement of the wafer 10, and a large amount of air is drawn through a wide gap between the inlets 44 and a mount plate lower than the wafer 10 together with the chemical solution, the de-ionized water, and the IPA. Therefore, since the suction pressure of the inlets above the wafer 10 is low, the inlets above the wafer 10 draw a small amount of air and liquid, which results in a scan tail defect 18. For this reason, in the equipment according to the related art, a plurality of inlets draw different amounts of air and chemical solution due to the step difference between the wafer 10 and the mount plate. As a result, the scan tail defect 18 occurs frequently. There is a well-cleaned region 16 in a first portion of the wafer 10 that is moved in the cleaning module. This is because a cleaning area is increased in the direction in which the wafer 10 is moved and the drawing of the chemical solution concentrates on the upper surface of the wafer 10 in the first portion. On the other hand, in a second portion of the wafer 10, the cleaning area is decreased, and the drawing of the chemical solution concentrates on the outside of the wafer 10. Therefore, the scan tail defect 18 occurs due to the chemical solution remaining on the upper surface of the wafer 10.

In the cleaning equipment according to an exemplary embodiment of the invention, air and a chemical solution are drawn through only the inlets 44 of the cells disposed above the wafer 10. Therefore, it is possible to substantially prevent the occurrence of the scan tail defect 18 due to the concentration of the drawing of the chemical solution.

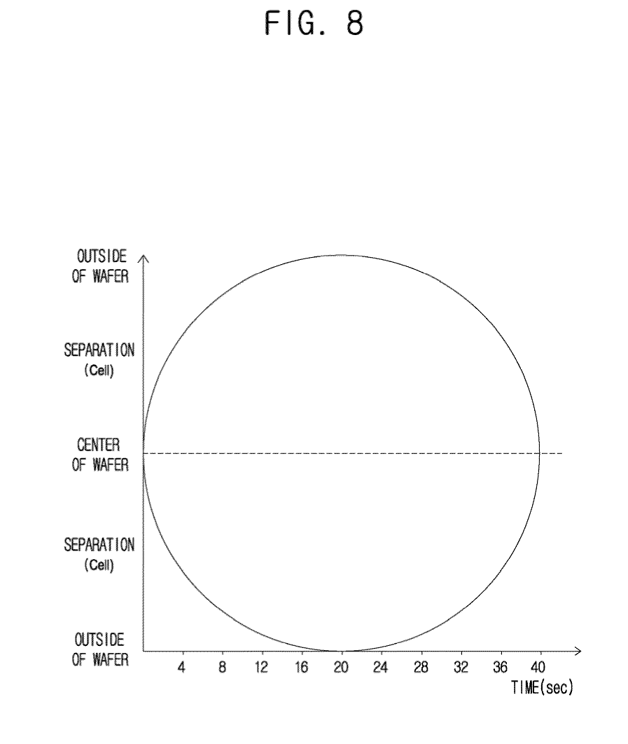

FIG. 8 is a graph illustrating the cleaning area of the cells 51 disposed above the wafer 10. As shown in FIG. 8, the cleaning area of a plurality of cells 51 formed in a line vertical to the direction in which the wafer 10 is moved may have a circular shape or a round diamond shape having apexes corresponding to the edge of the wafer 10. When a 10-inch wafer 10 is cleaned by a chemical solution, such as fluoric acid, the cleaning process is performed for about 40 seconds. According to an exemplary embodiment of the invention, a chemical solution and de-ionized water are supplied at a flow rate of about 2000 ml/min to about 3500 ml/min, and IPA is supplied at a flow rate of about 65 l/min.

A plurality of cells 51 discharge a chemical solution substantially localized to the wafer 10 and draw the chemical solution therefrom. Therefore, the cleaning area may be reduced to about the area of the wafer. According to an exemplary embodiment of the invention, only the cells 51 above the wafer 10 discharge or draw the chemical solution.

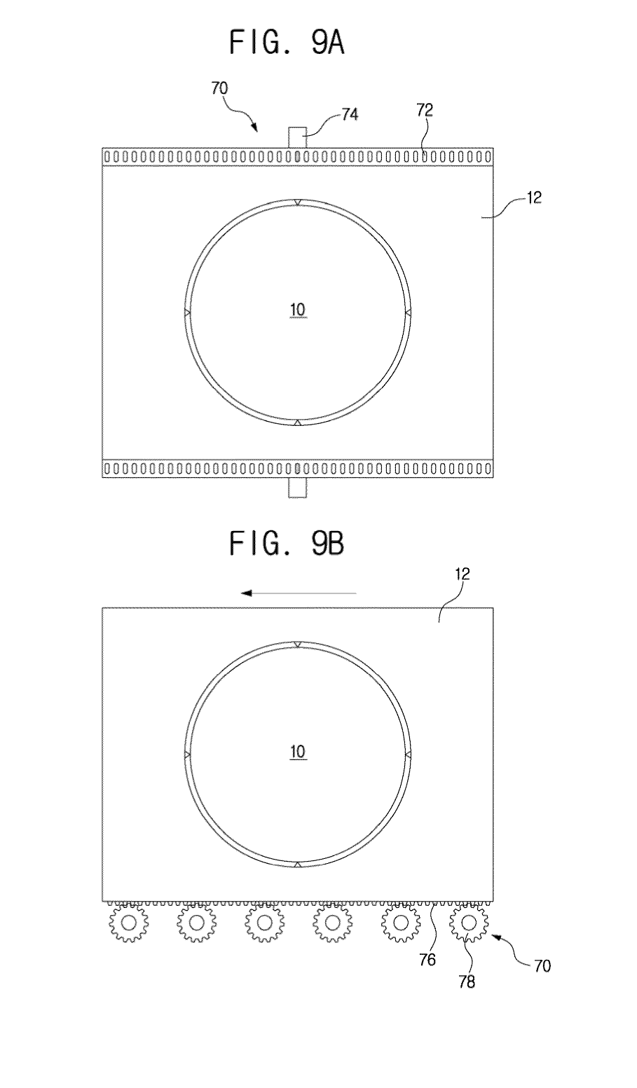

FIG. 9A and 9B are plan views illustrating a wafer position sensor 70 shown in FIG. 1. As shown in FIGS. 9A and 9B, the wafer position sensor 70 detects a position of the wafer 10 using punch holes 72 or saw teeth 76 formed at the edge of the mount plate 12 that supports the wafer 10.

The wafer position sensor 70 includes a puncture sensor 74 that checks the number of punch holes 72 to detect the position of the wafer 10. In addition, the wafer position sensor 70 may include a tooth gear sensor 78 that detects the position of the wafer 10 using a number of rotations of the tooth gear sensor engaged with the saw teeth 76. The wafer position sensor 70 that uses the punch holes 72 or the saw teeth 76 to detect the position of the wafer 10 is an indirect sensor. Although not shown in the drawings, a direct sensor, such as a photo sensor, that uses a light source, such as a laser or an infrared source, to detect the position of the wafer 10 may be used as the wafer position sensor 70.

Therefore, in the cleaning equipment according to an exemplary embodiment of the invention, a control unit detects the position of the wafer 10 on the basis of a detection signal output from the wafer position sensor 70 and controls a plurality of cells 51 disposed above the wafer 10 to clean the wafer 10.

Next, a method of cleaning a wafer in the cleaning equipment according to an exemplary embodiment of the invention will be described.

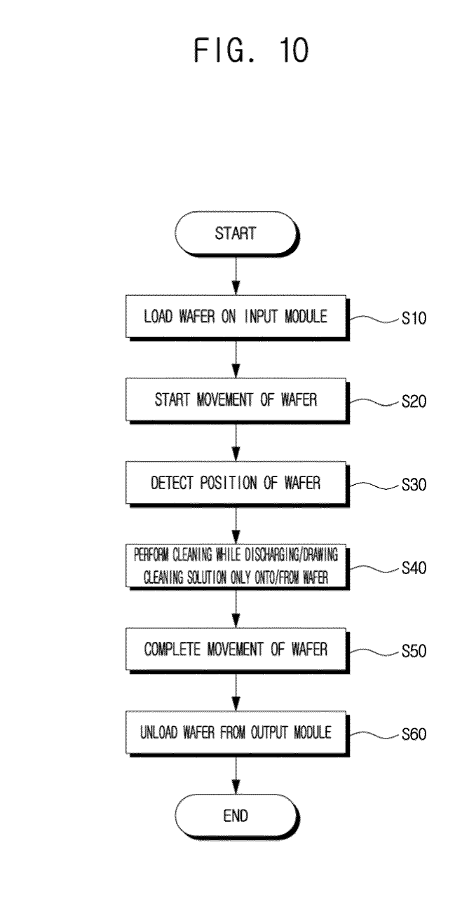

FIG. 10 is a flowchart illustrating a cleaning method according to an exemplary embodiment of the invention. The wafer 10 to be cleaned is loaded on the input module 20 (S10). Trenches are formed in the wafer 10, and contaminants in the trenches need to be cleaned. For example, there may be a silicon polymer or a photoresist in two-step trenches formed by a dual damascene process. The wafer 10 is horizontally loaded on the mount plate 12 by a robot.

The wafer 10 is horizontally moved from the input module 20 to the output module 30 (S20). The wafer 10 on the mount plate 12 is moved in a substantially straight line at a substantially constant speed.

The position of the wafer 10 is detected in the cleaning module 40 (S30). The control unit detects the position of the wafer 10 on the basis of the detection signal output from the wafer position sensor 70. Therefore, as the wafer 10 is moved, a plurality of cells 51 of the cleaning module 40 can individually clean the wafer 10.

Only the cells 51 disposed above the wafer 10 that is being moved through the cleaning module 40 discharge and draw the chemical solution to clean the wafer 10 (S40). As described above, the position of the wafer 10 may be determined on the basis of the detection signal output from the wafer position sensor 70, and the wafer 10 may be cleaned by the chemical solution discharged from the cells 51 disposed above the wafer 10. For example, the contaminant in the trenches formed in the wafer 10 may be cleaned by a chemical solution, such as fluoric acid or SC1. In addition, a plurality of cells 51 disposed above the wafer 10 discharge and draw de-ionized water and IPA to clean and dry the wafer 10. Therefore, in the cleaning method according to an exemplary embodiment of the invention, since a chemical solution, de-ionized water, and IPA are discharged only onto the upper surface of the wafer 10, it is possible to reduce manufacturing costs and improve productivity. In addition, it is possible to substantially prevent the occurrence of the scan tail defect 18 due to a difference in suction pressure caused by the step difference between the wafer 10 and the mount plate 12.

The movement of the wafer 10 is completed in the output module 30 (S50). The wafer 10, cleaned and dried by the cleaning module 40, is moved to the output module 30 and the horizontal movement of the wafer 10 stops. The wafer 10 is unloaded for a subsequent process (S60).

While exemplary embodiments have been shown and described with reference to the drawings, it will be understood by one of ordinary skill in the art that various changes in form and details may be made therein without departing from the spirit and scope of exemplary embodiments as defined by the following claims.

What is claimed is:

1. A cleaning equipment comprising:
an input module for receiving a wafer at a first position;
an output module outputting the wafer at a second position;
a moving module for moving the wafer from the first position to the second position; and
a cleaning module provided at a third position between the first and second positions and including a plurality of cells, each cell having one or more pairs of outlets and inlets, the outlets for discharging a chemical solution onto the wafer and the inlets for drawing the chemical solution from the wafer, in a movement path of the wafer,
wherein the plurality of cells are individually operated.

2. The cleaning equipment of claim 1,
wherein the cleaning module includes:
an upper cleaning module including the plurality of cells, wherein the outlets of different cells separately discharge the chemical solution onto the wafer and the inlets of the different cells separately draw the chemical solution from the wafer at a position above the wafer; and
a lower cleaning module including a plurality of collective outlets for collectively discharging the chemical solution and a plurality of collective inlets for collectively drawing the chemical solution at a position opposite to the upper cleaning module with the wafer interposed therebetween.

3. The cleaning equipment of claim 2, wherein the upper cleaning module includes an upper chemical cleaning unit that includes the plurality of cells.

4. The cleaning equipment of claim 3,
wherein the upper cleaning module further includes:
at least one chemical separation supply unit separately supplying the chemical solution to a first group of the plurality of cells corresponding to the upper chemical cleaning unit; and
at least one chemical separation suction unit separately drawing the chemical solution through a first group of the plurality of inlets formed in the plurality of cells.

5. The cleaning equipment of claim 2, wherein the lower cleaning module includes a lower chemical cleaning unit including a first group of the plurality of collective outlets that collectively discharge the chemical solution to a lower surface of the wafer and a first group of the plurality of collective inlets that collectively draw the chemical solution from the lower surface.

6. The cleaning equipment of claim 5,
wherein the lower cleaning module further includes:
at least one chemical collective supply unit collectively supplying the chemical solution to the lower chemical cleaning unit; and
a collective suction unit collectively drawing the chemical solution that is collectively discharged from the lower chemical cleaning unit to the lower surface of the wafer.

7. The cleaning equipment of claim 1, wherein a cleaning area formed by operating cells has apexes corresponding to an edge of the wafer.

8. The cleaning equipment of claim 1, further comprising:
a wafer position sensor detecting a position of the wafer.

9. The cleaning equipment of claim 8, wherein the wafer position sensor includes a mechanical sensor.

10. A cleaning method comprising:
operating, selectively, a plurality of cells in a cleaning module to discharge and draw at least one chemical solution to and from a wafer, wherein only cells disposed above the wafer are operated.

11. The cleaning method of claim 10, further comprising:
loading the wafer onto an input module;
moving the wafer from the input module to an output module; and
detecting the position of the wafer in the cleaning module between the input module and the output module.

12. The cleaning method of claim 10, further comprising:
completing the movement of the wafer from the cleaning module to the output module; and
taking out the wafer from the output module.

13. A cleaning equipment comprising:
a moving module for moving a wafer from a first position to a second position; and
a cleaning module provided at a third position between the first and second positions and including a plurality of cells, each cell having one or more pairs of outlets and inlets, the outlets for discharging a chemical solution onto the wafer and the inlets for drawing the chemical solution from the wafer, in a movement path of the wafer,
wherein the plurality of cells are individually operated.

14. The cleaning equipment of claim 13,
wherein the cleaning module includes:
an upper cleaning module including the plurality of cells, wherein the outlets of different cells separately discharge the chemical solution onto the wafer and the inlets of the different cells separately draw the chemical solution from the wafer at a position above the wafer; and
a lower cleaning module including a plurality of collective outlets for collectively discharging the chemical solution and a plurality of collective inlets for collectively drawing the chemical solution at a position opposite to the upper cleaning module with the wafer interposed therebetween.

15. The cleaning equipment of claim 14, wherein the upper cleaning module includes an upper chemical cleaning unit that includes the plurality of cells.

16. The cleaning equipment of claim 15,
wherein the upper cleaning module further includes:
at least one chemical separation supply unit separately supplying the chemical solution to a first group of the plurality of cells corresponding to the upper chemical cleaning unit; and
at least one chemical separation suction unit separately drawing the chemical solution through a first group of the plurality of inlets formed in the plurality of cells.

17. The cleaning equipment of claim 14, wherein the lower cleaning module includes a lower chemical cleaning unit including a first group of the plurality of collective outlets that collectively discharge the chemical solution to a lower surface of the wafer and a first group of the plurality of collective inlets that collectively draw the chemical solution from the lower surface.

18. The cleaning equipment of claim 17,
wherein the lower cleaning module further includes:
at least one chemical collective supply unit collectively supplying the chemical solution to the lower chemical cleaning unit; and
a collective suction unit collectively drawing the chemical solution that is collectively discharged from the lower chemical cleaning unit to the lower surface of the wafer.

19. The cleaning equipment of claim 13, wherein a cleaning area formed by operating cells has apexes corresponding to an edge of the wafer.

20. The cleaning equipment of claim 13, further comprising:
a wafer position sensor detecting a position of the wafer.
